(19) United States
(12) Patent Application Publication
(10) Pub. No.: US 2022/0132536 A1
(43) Pub. Date: Apr. 28, 2022

(54) METHOD AND APPARATUS FOR HYBRID AUTOMATIC REPEAT REQUEST FEEDBACK IN COMMUNICATION SYSTEM

(71) Applicant: ELECTRONICS AND TELECOMMUNICATIONS RESEARCH INSTITUTE, Daejeon (KR)

(72) Inventors: Mi Jeong YANG, Daejeon (KR); Soon Yong LIM, Daejeon (KR); Jae Sheung SHIN, Daejeon (KR); Sung Min OH, Daejeon (KR)

(73) Assignee: ELECTRONICS AND TELECOMMUNICATIONS RESEARCH INSTITUTE, Daejeon (KR)

(21) Appl. No.: 17/507,873

(22) Filed: Oct. 22, 2021

(30) Foreign Application Priority Data
Oct. 22, 2020 (KR) 10-2020-0137884
Oct. 5, 2021 (KR) 10-2021-0131920

(51) Int. Cl. H04W 72/12; H04W 72/04; H04L 1/18; H04L 5/00

(52) U.S. Cl. CPC H04W 72/1268; H04W 72/0446; H04L 5/0053; H04L 1/1812; H04W 72/1278

(57) ABSTRACT

An operation method of a terminal in a communication system may comprise: receiving configuration information of an SPS from a base station, the configuration information including a first HARQ offset for first data and a second HARQ offset for second data; receiving control information including information indicating activation of the SPS from the base station; receiving the first data and the second data from the base station based on the configuration information of the SPS; generating a first HARQ codebook including a first HARQ feedback for the first data and a second HARQ feedback for the second data; and transmitting the first HARQ codebook to the base station on a first PUCCH indicated by the first HARQ offset and the second HARQ offset, wherein a value of the first HARQ offset is different from a value of the second HARQ offset.

### CROSS-REFERENCE TO RELATED APPLICATIONS

This application claims priority to Korean Patent Applications No. 10-2020-0137884 filed on Oct. 22, 2020 and No. 10-2021-0131920 filed on Oct. 5, 2021 with the Korean Intellectual Property Office (KIPO), the entire contents of which are hereby incorporated by reference.

### BACKGROUND

### 1. Technical Field

The present disclosure relates to a grant-free scheme-based downlink communication technique in a communication system, and more particularly, to a technique for hybrid automatic repeat request (HARQ) feedback for grant-free scheme-based downlink data transmissions.

### 2. Related Art

The communication system (e.g., new radio (NR) communication system) using a higher frequency band (e.g., frequency band of 6 gigahertz (GHz) or above) than a frequency band (e.g., frequency band of 6 GHz or below) of the long term evolution (LTE) (or, LTE-A) is being considered for processing of soaring wireless data. The NR communication system may support not only a frequency band below 6 GHz but also a 6 GHz or higher frequency band, and may support various communication services and scenarios as compared to the LTE communication system. For example, usage scenarios of the NR communication system may include enhanced mobile broadband (eMBB), ultra-reliable low-latency communication (URLLC), massive machine type communication (mMTC), and the like.

The NR communication system aims at a high reliability and a transmission delay of 1 ms or less for the URLLC. As a scheduling scheme for satisfying such the URLLC requirements, a grant-free uplink/downlink data transmission scheme has been proposed.

However, since a value of K1 is fixed regardless of a time division duplex (TDD) pattern due to a semi-persistent scheduling (SPS) periodicity in units of slots, HARQ feedback information for a plurality of physical downlink shared channels (PDSCHs) may be omitted. This may cause a large number of PDSCH retransmissions and may cause a service delay.

### SUMMARY

In order to solve the above-identified problems, exemplary embodiments of the present disclosure are directed to providing a method and an apparatus of HARQ feedback for downlink data transmissions based on a grant-free scheduling scheme.

According to an exemplary embodiment of the present disclosure for achieving the above-described objective, an operation method of a terminal in a communication system may comprise: receiving configuration information of a semi-persistent scheduling (SPS) from a base station, the configuration information including a first hybrid automatic repeat request (HARQ) offset for first data and a second HARQ offset for second data; receiving control information including information indicating activation of the SPS from the base station; receiving the first data and the second data from the base station based on the configuration information of the SPS; generating a first HARQ codebook including a first HARQ feedback for the first data and a second HARQ feedback for the second data; and transmitting the first HARQ codebook to the base station on a first physical uplink control channel (PUCCH) indicated by the first HARQ offset and the second HARQ offset, wherein a value of the first HARQ offset is different from a value of the second HARQ offset.

The configuration information of the SPS may include at least one of a number of slots, an index of an uplink slot including the first PUCCH for the first HARQ feedback and the second HARQ feedback, and a first PUCCH resource list of PUCCH resources capable of accommodating both the first HARQ feedback and the second HARQ feedback.

When the SPS is configured in the terminal, the first PUCCH resource may be determined according to the first PUCCH resource list included in the configuration information of the SPS.

The operation method may further comprise receiving the first data again from the base station when the first HARQ feedback corresponds to negative acknowledgment (NACK).

The operation method may further comprise: receiving third data from the base station based on the configuration information of the SPS; generating a second HARQ codebook including a third HARQ feedback for the third data; and when a delay time for the third HARQ feedback is required, transmitting the second HARQ codebook to the base station on a second PUCCH indicated by a third HARQ offset included in the configuration information of the SPS, wherein the second PUCCH is included in a subsequent uplink slot contiguous to the uplink slot including the first PUCCH.

According to another exemplary embodiment of the present disclosure for achieving the above-described objective, an operation method of a base station in a communication system may comprise: transmitting configuration information of an SPS to a terminal, the configuration information including a first HARQ offset for first data and a second HARQ offset for second data; transmitting control information including information indicating activation of the SPS to the terminal; transmitting the first data and the second data to the terminal based on the configuration information of the SPS; and receiving, from the terminal, a first HARQ codebook including a first HARQ feedback for the first data and a second HARQ feedback for the second data on a first PUCCH indicated by the first HARQ offset and the second HARQ offset, wherein a value of the first HARQ offset is different from a value of the second HARQ offset.

When the SPS is configured in the terminal, the first PUCCH resource may be determined according to a first PUCCH resource list included in the configuration information of the SPS.

The operation method may further comprise: transmitting third data to the terminal based on the configuration information of the SPS; when a delay time for a third HARQ feedback for the third data is required, receiving, from the terminal, a second HARQ codebook including the third HARQ feedback on a second PUCCH indicated by a third HARQ offset included in the configuration information of the SPS, wherein the second PUCCH is included in a subsequent uplink slot contiguous to the uplink slot including the first PUCCH.

According to yet another exemplary embodiment of the present disclosure for achieving the above-described objective, a terminal in a communication system may comprise: a processor; a memory electronically communicating with the processor; and instructions stored in the memory, wherein when executed by the processor, the instructions cause the terminal to: receive configuration information of an SPS from a base station, the configuration information including a first HARQ offset for first data and a second HARQ offset for second data; receive control information including information indicating activation of the SPS from the base station; receive the first data and the second data from the base station based on the configuration information of the SPS; generate a first HARQ codebook including a first HARQ feedback for the first data and a second HARQ codebook including a second HARQ feedback for the second data; transmit the first HARQ codebook to the base station on a first physical uplink control channel (PUCCH) indicated by the first HARQ offset; and when a delay time for the second HARQ feedback is required, transmitting the second HARQ codebook to the base station on a second PUCCH indicated by the second HARQ offset, wherein a value of the first HARQ offset is different from a value of the second HARQ offset.

The instructions may further cause the terminal to receive third data from the base station based on the configuration information of the SPS, wherein the second HARQ codebook may further include a third HARQ feedback for the third data, the configuration information of the SPS may further include a third HARQ offset for the third data, and the third HARQ offset may indicate the second PUCCH.

The configuration information of the SPS includes at least one of a number of slots, an index of an uplink slot including the first PUCCH for the first HARQ feedback, an index of an uplink slot including the second PUCCH for the second HARQ feedback and the third HARQ feedback, a first PUCCH resource list of PUCCH resources capable of accommodating the first HARQ feedback, and a second PUCCH resource list of PUCCH resources capable of accommodating both the second HARQ feedback and the third HARQ feedback.

When the SPS is configured in the terminal, the first PUCCH resource may be determined according to the first PUCCH resource list included in the configuration information of the SPS, and the second PUCCH resource may be determined according to the second PUCCH resource list included in the configuration information of the SPS.

According to the exemplary embodiments of the present disclosure, when the SPS scheme, which is a grant-free scheduling scheme having a periodicity in units of slots, omission of HARQ feedbacks can be prevented and URLLC service data can be efficiently transmitted. Accordingly, reliability of the SPS scheme can be improved in a communication system for satisfying the URLLC requirements, and thus the performance of the communication system can be improved.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a slot offset from a timing of downlink transmission to a timing of feedback transmission for the downlink transmission in a communication system.

FIG. 4 is a sequence chart illustrating a HARQ feedback method for downlink data transmission based on a grant-free scheduling scheme in a communication system.

FIG. 5 is a conceptual diagram illustrating a first exemplary embodiment of a HARQ feedback method for downlink data transmission based on a grant-free scheduling scheme in a communication system.

FIG. 6 is a conceptual diagram illustrating a second exemplary embodiment of a HARQ feedback method for downlink data transmission based on a grant-free scheduling scheme in a communication system.

FIG. 7 is a conceptual diagram illustrating an SPS-UL-DL pattern in a communication system.

FIG. 8 is a conceptual diagram illustrating a first exemplary embodiment of a HARQ feedback method for a plurality of PDSCHs in a communication system.

FIG. 9 is a sequence chart illustrating a first exemplary embodiment of a HARQ feedback method for a plurality of PDSCHs in a communication system.

FIG. 10 is a conceptual diagram illustrating RRC configuration for the first exemplary embodiment of the HARQ feedback method for a plurality of PDSCHs in a communication system.

FIG. 11 is a conceptual diagram illustrating a second exemplary embodiment of a HARQ feedback method for a plurality of PDSCHs in a communication system.

FIG. 12 is a conceptual diagram illustrating a third exemplary embodiment of a HARQ feedback method for a plurality of PDSCHs in a communication system.

FIG. 13 is a conceptual diagram illustrating a fourth exemplary embodiment of a HARQ feedback method for a plurality of PDSCHs in a communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

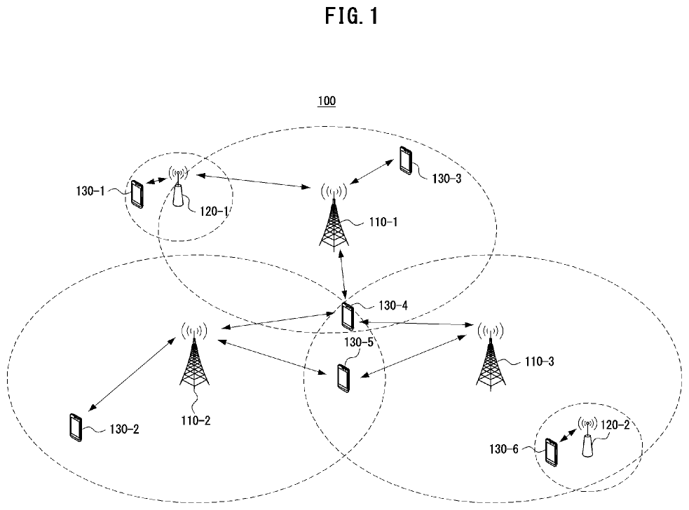

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4^{th} generation (4G) communication (e.g., long term evolution (LTE), LTE-advanced (LTE-A)), 5^{th} generation (5G) communication (e.g., new radio (NR)), or the like. The 4G communication may be performed in a frequency band of 6 GHz or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

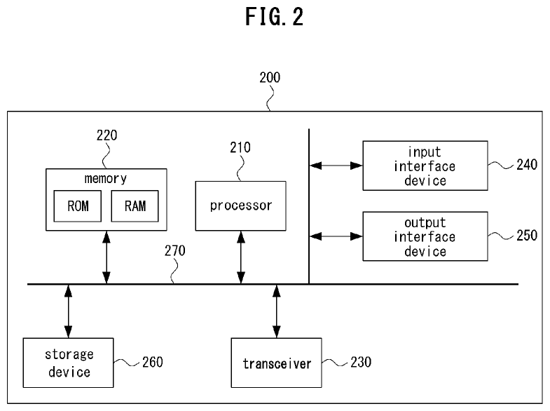

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), base transceiver station (BTS), radio base station, radio transceiver, access point, access node, road side unit (RSU), radio remote head (RRH), transmission point (TP), transmission and reception point (TRP), eNB, gNB, or the like.

Here, each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of things (IoT) device, mounted apparatus (e.g., a mounted module/device/terminal or an on-board device/terminal, etc.), or the like.

Hereinafter, methods for grant-free scheduling will be described. In case of uplink scheduling, a terminal may receive a scheduling grant from a base station, when the terminal is scheduled. The scheduling grant may include an indication of time, frequency, and spatial resources to be used for transmission of an uplink-shared channel (UL-SCH) and a transmission format associated therewith. Uplink data transmission can be performed only when the terminal receives a valid grant. However, in case of dynamic scheduling, when it is necessary to operate without a control signal in order to flexibly cope with rapidly changing traffic characteristics, the terminal may perform uplink transmission without a scheduling grant.

The base station may support, through radio resource control (RRC) signaling in downlink, a configuration in which the terminal can periodically transmit uplink data. This may be referred to as semi-persistent scheduling (SPS) or semi-static scheduling.

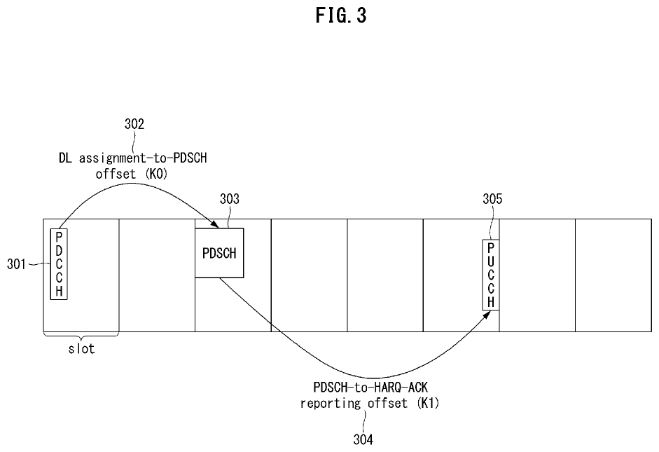

FIG. 3 is a conceptual diagram illustrating a slot offset from a timing of downlink transmission to a timing of feedback transmission for the downlink transmission in a communication system.

Referring to FIG. 3, the base station may transmits first downlink control information (DCI) to the terminal on a physical downlink control channel (PDCCH) 301, thereby delivering one or more control information related to first downlink data to be transmitted to the terminal. For example, the first DCI transmitted by the base station to the terminal may include information of a first offset. Here, the first offset 302 may be a slot interval between a timing of transmitting the PDCCH 301 and a timing of transmitting of a PDSCH 303 in the time domain. The first offset may be referred to as a ‘DL assignment-to-PDSCH offset’ or ‘K0’. Meanwhile, the first DCI transmitted by the base station to the terminal may include information of a second offset. Here, the second offset 304 may be a slot interval between the timing of transmitting the PDSCH 303 and a timing of transmitting of a HARQ feedback for the PDSCH 303 (e.g., a timing of transmitting a PUCCH 305) in the time domain. The second offset may be referred to as a ‘PDSCH-to-HARQ-ACK reporting offset’ or ‘K1’.

In the HARQ feedback scheme, when a receiving node (e.g., terminal) succeeds in decoding a first signal (e.g., data) received from a transmitting node (e.g., base station), the receiving node may transmit to the transmitting node a HARQ feedback indicating that the first signal is normally decoded. Here, the HARQ feedback indicating that the first signal is normally decoded may correspond to acknowledgement (ACK). On the other hand, when the decoding of the first signal received from the transmitting node fails, the receiving node may transmit to the transmitting node a HARQ feedback indicating that the first signal is not normally decoded. Here, the HARQ feedback indicating that the first signal is not normally decoded may correspond to negative acknowledgement (NACK). When the transmitting node receives the NACK from the receiving node, the transmitting node may determine that the first signal is not normally received at the receiving node, and may perform an operation of retransmitting the first signal.

Bits transmitted as a HARQ feedback may be defined in form of a HARQ codebook. The HARQ codebook may be referred to also as a HARQ-ACK codebook. The HARQ codebook may be a set of HARQ feedback information bits, and may be generated based on a dynamic codebook scheme or a semi-static codebook scheme. In the dynamic codebook scheme, the size of the HARQ codebook (e.g., type 2 HARQ-ACK codebook) may be determined based on PDSCH(s) actually scheduled for transmission of downlink data.

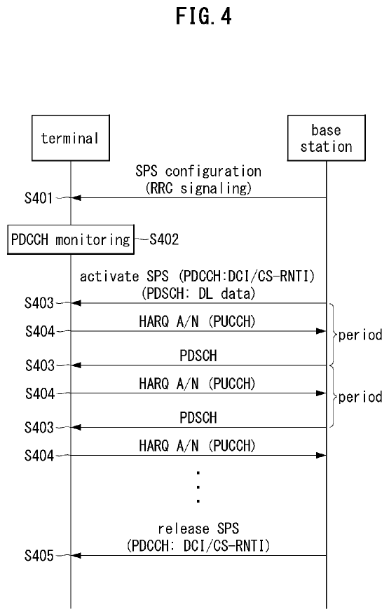

FIG. 4 is a sequence chart illustrating a HARQ feedback method for downlink data transmission based on a grant-free scheduling scheme in a communication system.

Referring to FIG. 4, the base station may configure an SPS to the terminal through RRC signaling (S401). The base station may configure a configured scheduling-radio network temporary identifier (CS-RNTI), nrofHARQ-Processes, harq-ProcID-Offset, periodicity, and/or the like to the terminal through RRC signaling. The above-described information may be referred to as ‘SPS configuration information’. The terminal may receive the SPS configuration information from the base station through RRC signaling. The terminal may perform a PDCCH monitoring operation (S402). The base station may transmit a DCI scrambled by the CS-RNTI to the terminal. The terminal may receive the DCI scrambled by the CS-RNTI from the base station. The base station may activate or deactivate the SPS configured in the terminal through the DCI scrambled by the CS-RNTI. When the SPS is activated, the base station may transmit PDSCH(s) according to the preconfigured periodicity (S403). In the step 403, the PDSCH(s) may be transmitted based on information included in the DCI for activating the SPS. When the SPS is activated, the terminal may receive PDSCH(s) according to the preconfigured periodicity. Whenever the terminal periodically receives a PDSCH from the base station, the terminal may transmit a HARQ feedback for the received PDSCH to the base station (S404). Whenever the base station periodically transmits a PDSCH to the terminal, the base station may receive a HARQ feedback therefor from the terminal. The base station may transmit a DCI for releasing the SPS to the terminal (S405). The terminal may periodically receive PDSCH(s) based on the grant-free scheme until the terminal receives a DCI for releasing the SPS from the base station.

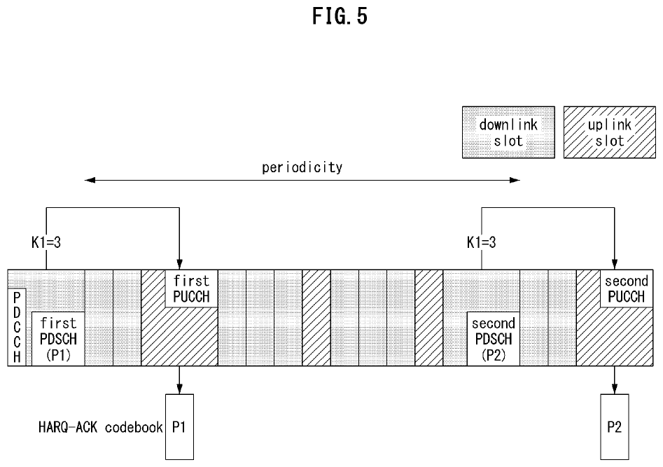

FIG. 5 is a conceptual diagram illustrating a first exemplary embodiment of a HARQ feedback method for downlink data transmission based on a grant-free scheduling scheme in a communication system.

Referring to FIG. 5, after the SPS is activated, the terminal may periodically receive PDSCH(s) (e.g., PDSCH for the n-th HARQ process number Pn), and may transmit HARQ feedback(s) for the PDSCH(s) to the base station. The terminal may use a value (i.e., K1) of a PDSCH-to-HARQ feedback timing indicator field included in the DCI to periodically transmit the HARQ feedback(s) (e.g., HARQ codebook) to the base station through preconfigured PUCCH resource(s) after a time corresponding to K1 (i.e., slot offset) elapses from the respective slot(s) in which the respective PDSCH(s) are received. Here, K1 may be referred to as a ‘HARQ offset’. If there is no PDSCH-to-HARQ_feedback timing indicator field in the DCI, the terminal may transmit the HARQ feedback(s) to the base station by using a value of dl-DataToUL-ACK, which is a value configured through RRC signaling.

For example, the base station may transmit a first PDSCH to the terminal based on information included in the DCI. The terminal may receive the first PDSCH (i.e., PDSCH for P1) from the base station, and transmit a HARQ codebook to the base station in a slot (i.e., first PUCCH) according to the value (i.e., K1) of the PDSCH-to-HARQ feedback timing indicator field included in the DCI. The base station may receive the HARQ codebook on the first PUCCH, and may identify the HARQ feedback for the first PDSCH.

In addition, the base station may transmit a second PDSCH to the terminal. The terminal may receive the second PDSCH (i.e., PDSCH for P2) from the base station, and transmit a HARQ codebook to the base station in a slot (i.e., second PUCCH) according to the value K1 of the PDSCH-to-HARQ feedback timing indicator field included in the DCI. The base station may receive the HARQ codebook on the second PUCCH, and may identify the HARQ feedback for the second PDSCH.

In the communication system, a minimum of 10 ms and a maximum of 640 ms may be supported as the SPS periodicity. However, the SPS periodicity may be extended in units of slots as shown in Table 1 below to satisfy the low-latency requirement.

TABLE 1

| Subcarrier | |
|---|---|
| spacing | Periodicity (ms) |
| 15 kHz | 1~640 |
| 30 kHz | 1~1280 [symbol] 0.5~640 (in units of 0.5) |
| 60 kHz | 1~2560 [symbol] 0.25~640 (in units of 0.25) |
| (normal CP) | |
| 60 kHz | 1~2560 [symbol] 0.25~640 (in units of 0.25) |
| (extended CP) | |
| 120 kHz | 1~5120 [symbol] 0.125~640 (in units of 0.125) |

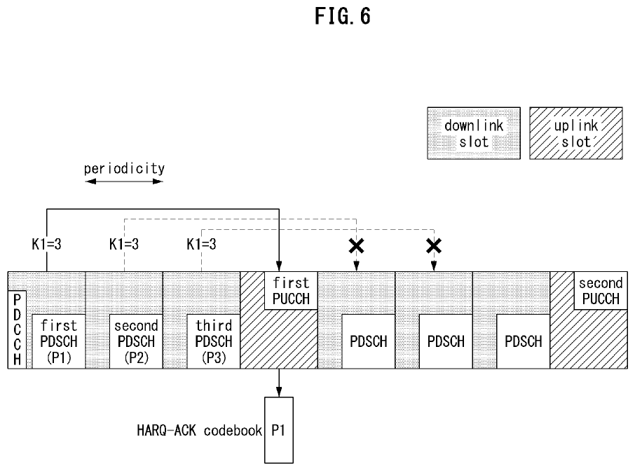

FIG. 6 is a conceptual diagram illustrating a second exemplary embodiment of a HARQ feedback method for downlink data transmission based on a grant-free scheduling scheme in a communication system.

Referring to FIG. 6, the following problem may occur due to the SPS periodicity in units of slots in the conventional communication system. As the value of K1 is fixed regardless of a TDD pattern by TDD-UL-DL-Config, HARQ feedback information for a plurality of PDSCHs may be omitted.

For example, since the slot offset (i.e., K1) has a fixed value of 3, the terminal may generate a HARQ codebook including a HARQ feedback for the first PDSCH (i.e., PDSCH for P1), and may transmit the HARQ codebook to the base station in a slot (i.e., first PUCCH) according to the slot offset. However, a HARQ feedback for the second PDSCH (i.e., PDSCH for P2) cannot be transmitted on the first PUCCH. Also, the terminal cannot transmit a HARQ feedback for the third PDSCH (i.e., PDSCH for P3) on the first PUCCH.

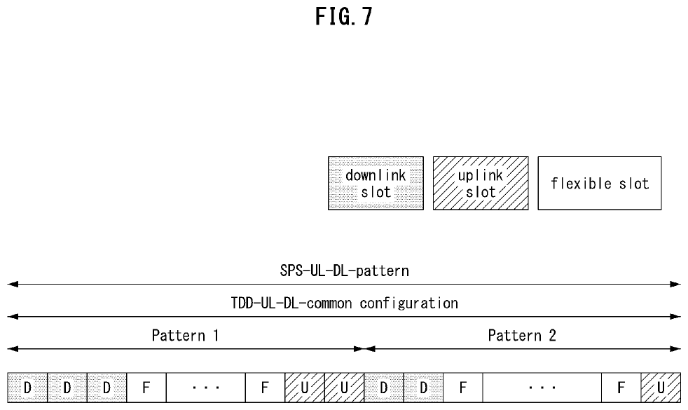

FIG. 7 is a conceptual diagram illustrating an SPS-UL-DL pattern in a communication system.

Referring to FIG. 7, the base station may define an SPS-UL-DL pattern matching a semi-static TDD pattern. The terminal may transmit a plurality of HARQ feedbacks for a plurality of PDSCHs within the SPS-UL-DL pattern to the base station by using PUCCH resources in one uplink slot. Accordingly, the PUCCH resources in the uplink slot may include resources for transmission of HARQ feedbacks for a plurality of PDSCHs having different K1 values.

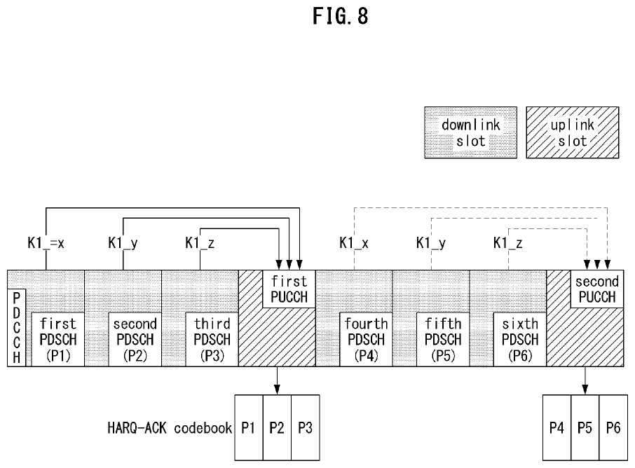

FIG. 8 is a conceptual diagram illustrating a first exemplary embodiment of a HARQ feedback method for a plurality of PDSCHs in a communication system.

Referring to FIG. 8, in order to solve the problem that HARQ feedback(s) for PDSCH(s) may be omitted according to the conventional SPS having the same value of K1, the base station may set different K1 values for the respective PDSCHs. The terminal may transmit HARQ feedbacks for one or more PDSCHs received from the base station within an SPS-UL-DL-pattern to the base station, by using one PUCCH. The base station may receive the HARQ feedbacks for the one or more PDSCHs from the terminal on the one PUCCH.

Accordingly, the base station may designate an uplink slot in which a PUCCH can be configured for transmitting the HARQ feedbacks within the SPS-UL-DL-pattern. The base station may configure slot offsets (i.e., K1_n) of the one or more PDSCHs for which the HARQ feedbacks are to be transmitted in the designated uplink slot. For example, the base station may configure K1_x for the first PDSCH, K1_y for the second PDSCH, and K1_z for the third PDSCH, and may inform the terminal of the slot offsets (i.e., K1_x, K1_y, and K1_z). The terminal may identify the slot offsets from the base station, and may transmit a HARQ codebook to the base station in the slot (e.g., PUCCH) according to the slot offsets.

That is, the base station may transmit a first PDSCH (i.e., PDSCH for P1), a second PDSCH (i.e., PDSCH for P2), and a third PDSCH (i.e., PDSCH for P3) to the terminal according to the SPS. The terminal may receive the first PDSCH, the second PDSCH, and the third PDSCH from the base station, generate a HARQ codebook including a HARQ feedback for the first PDSCH, a HARQ feedback for the second PDSCH, and a HARQ feedback for the third PDSCH, and transmit the HARQ codebook to the base station on the PUCCH (i.e., first PUCCH) indicated by the slot offsets. The base station may receive the HARQ codebook from the terminal on the first PUCCH according to the slot offsets, and may identify the HARQ feedback for the first PDSCH, the HARQ feedback for the second PDSCH, and the HARQ feedback for the third PDSCH, which are included in the HARQ codebook.

In addition, the base station may transmit a fourth PDSCH (i.e., PDSCH for P4), a fifth PDSCH (i.e., PDSCH for P5), and a sixth PDSCH (i.e., PDSCH for P6) to the terminal according to the SPS. The terminal may receive the fourth PDSCH, the fifth PDSCH, and the sixth PDSCH from the base station, generate a HARQ codebook including a HARQ feedback for the fourth PDSCH, a HARQ feedback for the fifth PDSCH, and a HARQ feedback for the sixth PDSCH, and transmit the HARQ codebook to the base station on a PUCCH (i.e., second PUCCH) indicated by the slot offsets. The base station may receive the HARQ codebook from the terminal on the second PUCCH according to the slot offsets, and may identify the HARQ feedback for the fourth PDSCH, the HARQ feedback for the fifth PDSCH, and the HARQ feedback for the sixth PDSCH, which are included in the HARQ codebook.

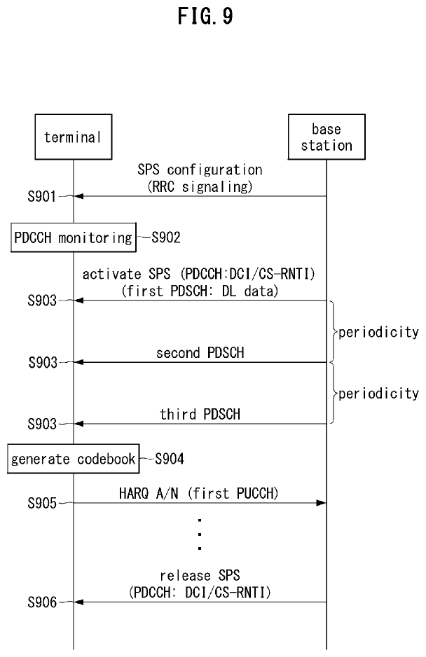

FIG. 9 is a sequence chart illustrating a first exemplary embodiment of a HARQ feedback method for a plurality of PDSCHs in a communication system.

Referring to FIG. 9, the base station may configure an SPS including information on PUCCH resource(s) to the terminal through RRC signaling (S901). The terminal may receive SPS configuration information including the information on the PUCCH resource(s) from the base station. Each of PUCCH resource(s) may be defined by a value of K1_n (i.e., a slot offset between each PDSCH and a PUCCH resource corresponding to the PDSCH).

That is, the base station may designate an uplink slot in which a PUCCH can be configured for transmitting HARQ feedbacks within an SPS-UL-DL-pattern. The base station may configure a slot offset (i.e., K1_x) of a first PDSCH, a slot offset (i.e., K1-y) of a second PDSCH, and a slot offset (i.e., K1_z) of a third PDSCH. HARQ feedbacks for the first, second, and third PDSCH may be transmitted in the designated uplink slot. The base station may inform the terminal of the slot offsets (i.e., K1_x, K1 y, and K1_z). The terminal may identify the slot offsets from the base station.

The terminal may perform a PDCCH monitoring operation (S902). The base station may transmit a DCI including a ‘PUCCH resource indicator’ field and a ‘PDSCH-to-HARQ feedback timing indicator’ field to the terminal. The terminal may receive the DCI including the PUCCH resource indicator field and the PDSCH-to-HARQ feedback timing indicator field from the base station. The base station may determine the PUCCH resource and the transmission timing for the HARQ feedbacks based on field values included in the DCI as shown in Table 2 below.

TABLE 2

| | Size (bits) | Size (bits) | Size (bits) |
|---|---|---|---|
| | (DCI format | (DCI format | (DCI format |
| IE | 1_0) | 1_1) | 1_2) |
| PUCCH resource | 3 | 3 | 0, 1, 2, or 3 |
| indicator | | | |
| PDSCH-to-HARQ | 3 | 0, 1, 2, or 3 | 0, 1, 2, or 3 |
| feedback timing | | | |
| indicator | | | |

The base station may transmit the first PDSCH (i.e., PDSCH for P1), the second PDSCH (i.e., PDSCH for P2), and the third PDSCH (i.e., PDSCH for P3) to the terminal according to the SPS (S903). The terminal may receive the first PDSCH, the second PDSCH, and the third PDSCH from the base station. The terminal may generate a HARQ codebook including a HARQ feedback for the first PDSCH, a HARQ feedback for the second PDSCH, and a HARQ feedback for the third PDSCH (S904). The terminal may transmit the HARQ codebook to the base station on the PUCCH (i.e., first PUCCH) indicated by the slot offsets (S905). The base station may receive the HARQ codebook from the terminal on the first PUCCH according to the slot offsets, and may identify the HARQ feedback for the first PDSCH, the HARQ feedback for the second PDSCH, and the HARQ feedback for the third PDSCH, which are included in the HARQ codebook.

The terminal may receive the HARQ feedback-related parameter values of Table 2 above from the base station. However, when the value of K1_n and the PUCCH resource for transmitting the HARQ feedback for the PDSCH is already configured in the terminal through RRC signaling, the terminal may not follow the field values of Table 2 above, and may transmit the HARQ codebook to the base station according to the K1_n value and the PUCCH resource for transmitting the HARQ feedback, which are configured through RRC signaling.

The base station may transmit a DCI for releasing the SPS to the terminal (S906). The terminal may periodically receive the PDSCHs until it receives the DCI for releasing the SPS from the base station.

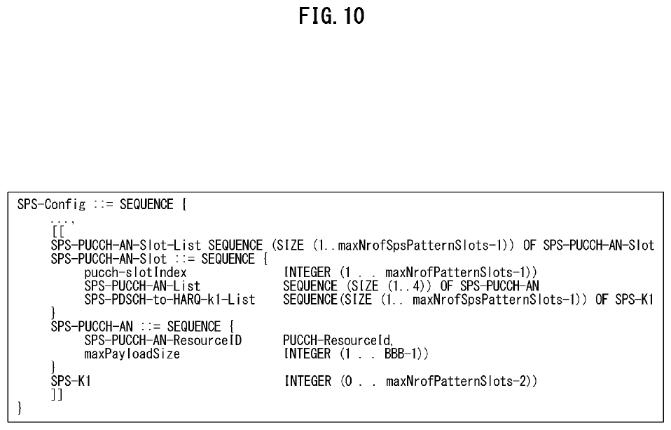

FIG. 10 is a conceptual diagram illustrating RRC configuration for the first exemplary embodiment of the HARQ feedback method for a plurality of PDSCHs in a communication system.

Referring to FIG. 10, RRC configuration for the first exemplary embodiment of the HARQ feedback method for a plurality of PDSCHs may be shown. Parameters defined in the RRC configuration may be as follows. ‘maxNrofPatternSlots’ may indicate the number of slots within the SPS-UL-DL-pattern. ‘SPS-PUCCH-AN-Slot’ may indicate an index of an uplink slot including a PUCCH for HARQ feedbacks within the SPS-UL-DL-pattern. ‘SPS-PUCCH-AN-List’ may mean a list of PUCCH resource(s) that can accommodate all of the HARQ feedbacks transmitted in a slot indicated by pucch-slotIndex. ‘SPS-K1’ may mean a slot offset between a PDSCH and a PUCCH corresponding to the PDSCH.

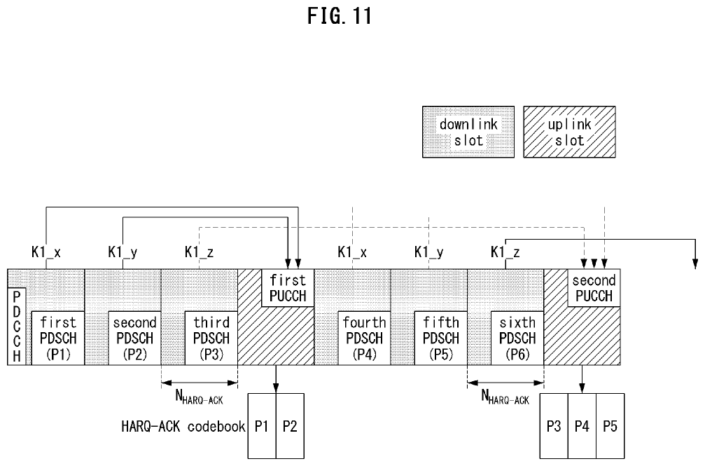

FIG. 11 is a conceptual diagram illustrating a second exemplary embodiment of a HARQ feedback method for a plurality of PDSCHs in a communication system.

Referring to FIG. 11, the base station may configure K1_x for a first PDSCH, K1_y for a second PDSCH, and K1_z for a third PDSCH, and may inform the terminal of the slot offsets (i.e., K1_x, K1_y, and K1_z). The terminal may identify the slot offsets from the base station, and may transmit a HARQ codebook to the base station in a slot (e.g., PUCCH) according to the slot offsets. That is, the base station may transmit the first PDSCH (i.e., PDSCH for P1), the second PDSCH (i.e., PDSCH for P2), and the third PDSCH (i.e., PDSCH for P3) to the terminal according to the SPS. The terminal may receive the first PDSCH, the second PDSCH, and the third PDSCH from the base station.

If a delay time (i.e., N_{HARQ-ARK}) for preparing for transmission of a HARQ feedback for a PDSCH is required according to capability of the terminal, the terminal may not be able to transmit a HARQ feedback for the third PDSCH in the slot (i.e., first PUCCH) according to the slot offsets. In this case, the terminal may generate a HARQ codebook including a HARQ feedback for the first PDSCH and a HARQ feedback for the second PDSCH, and transmit the HARQ codebook to the base station on the PUCCH (i.e., first PUCCH) indicated by the slot offsets. The HARQ feedback for the third PDSCH may be transmitted on the next PUCCH (i.e., second PUCCH). The base station may receive the HARQ codebook from the terminal on the PUCCH (i.e., first PUCCH) according to the slot offsets, and may identify the HARQ feedback for the first PDSCH and the HARQ feedback for the second PDSCH, which are included in the HARQ codebook.

In addition, the base station may transmit a fourth PDSCH (i.e., PDSCH for P4), a fifth PDSCH (i.e., PDSCH for P5), and a sixth PDSCH (i.e., PDSCH for P6) to the terminal according to the SPS. The terminal may receive the fourth PDSCH, the fifth PDSCH, and the sixth PDSCH from the base station.

If a delay time (i.e., N_{HARQ-ARK}) for preparing for transmission of a HARQ feedback for a PDSCH is required according to capability of the terminal, the terminal may not be able to transmit a HARQ feedback for the sixth PDSCH in the slot (i.e., second PUCCH) according to the slot offsets. In this case, the terminal may generate a HARQ codebook including a HARQ feedback for the fourth PDSCH and a HARQ feedback for the fifth PDSCH. The terminal may transmit the HARQ codebook to the base station on the PUCCH (i.e., second PUCCH) indicated by the slot offsets. The HARQ feedback for the sixth PDSCH may be transmitted on the next PUCCH (not shown). The base station may receive the HARQ codebook from the terminal on the PUCCH (i.e., second PUCCH) according to the slot offsets, and may identify the HARQ feedback for the third PDSCH, the HARQ feedback for the fourth PDSCH, and HARQ feedback for the fifth PDSCH, which are included in the HARQ codebook.

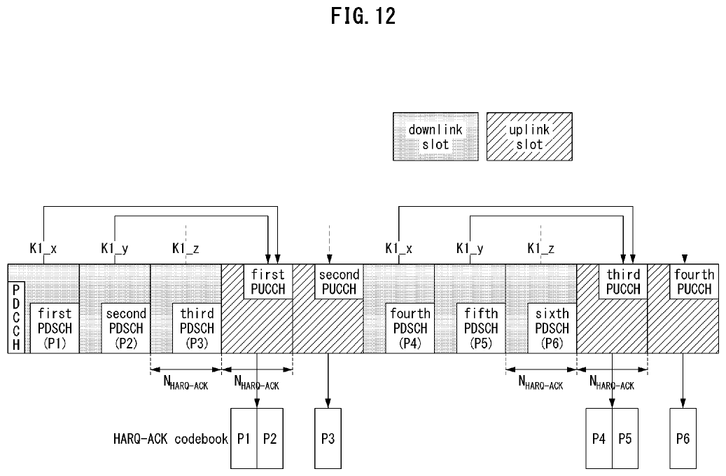

FIG. 12 is a conceptual diagram illustrating a third exemplary embodiment of a HARQ feedback method for a plurality of PDSCHs in a communication system.

Referring to FIG. 12, the base station may configure K1_x for a first PDSCH, K1_y for a second PDSCH, and K1_z for a third PDSCH, and inform the terminal of the slot offsets (i.e., K1_x, K1_y, and K1_z). The above-described operations may be applied when uplink slots are contiguous. The terminal may identify the slot offsets from the base station, and may transmit a HARQ codebook to the base station in a slot (i.e., first PUCCH) according to the slot offsets. That is, the base station may transmit the first PDSCH (i.e., PDSCH for P1), the second PDSCH (i.e., PDSCH for P2), and the third PDSCH (i.e., PDSCH for P3) to the terminal according to the SPS. The terminal may receive the first PDSCH, the second PDSCH, and the third PDSCH from the base station.

If a delay time (i.e., N_{HARQ-ARK}) for preparing for transmission of a HARQ feedback for a PDSCH is required according to capability of the terminal, the terminal may not be able to transmit a HARQ feedback for the third PDSCH in the slot (i.e., first PUCCH) according to the slot offsets. In this case, the terminal may generate a HARQ codebook including a HARQ feedback for the first PDSCH and a HARQ feedback for the second PDSCH, and transmit the HARQ codebook to the base station on the PUCCH (i.e., first PUCCH) indicated by the slot offsets. The HARQ feedback for the third PDSCH may be transmitted on a PUCCH (i.e., second PUCCH) in an uplink slot contiguous with the slot according to the slot offsets. The base station may receive the HARQ codebook from the terminal on the PUCCH (i.e., first PUCCH) according to the slot offsets, and may identify the HARQ feedback for the first PDSCH and the HARQ feedback for the second PDSCH, which are included in the HARQ codebook. In addition, the base station may receive the HARQ feedback for the third PDSCH on the second PUCCH.

In addition, the base station may transmit a fourth PDSCH (i.e., PDSCH for P4), a fifth PDSCH (i.e., PDSCH for P5), and a sixth PDSCH (i.e., PDSCH for P6) to the terminal according to the SPS. The terminal may receive the fourth PDSCH, the fifth PDSCH, and the sixth PDSCH from the base station.

If a delay time (i.e., N_{HARQ-ARK}) for preparing for transmission of a HARQ feedback for a PDSCH is required according to capability of the terminal, the terminal may not be able to transmit a HARQ feedback for the sixth PDSCH in the slot (i.e., third PUCCH) according to the slot offsets.

In this case, the terminal may generate a HARQ codebook including a HARQ feedback for the fourth PDSCH and a HARQ feedback for the fifth PDSCH. The terminal may transmit the HARQ codebook to the base station on the PUCCH (i.e., third PUCCH) indicated by the slot offsets. The HARQ feedback for the sixth PDSCH may be transmitted on a PUCCH (i.e., fourth PUCCH) in an uplink slot contiguous with the slot according to the slot offsets. The base station may receive the HARQ codebook from the terminal on the PUCCH (i.e., third PUCCH) according to the slot offsets, and identify the HARQ feedback for the fourth PDSCH and the HARQ feedback for the fifth PDSCH included in the HARQ codebook. In addition, the base station may receive the HARQ feedback for the sixth PDSCH on the fourth PUCCH.

In case of the HARQ feedback methods according to the above-described first to third exemplary embodiments, the terminal may not follow the values of the PUCCH resource indicator field and the PDSCH-to-HARQ feedback timing indicator field included in the DCI received from the base station, and may follow RRC configuration values configured through RRC signaling.

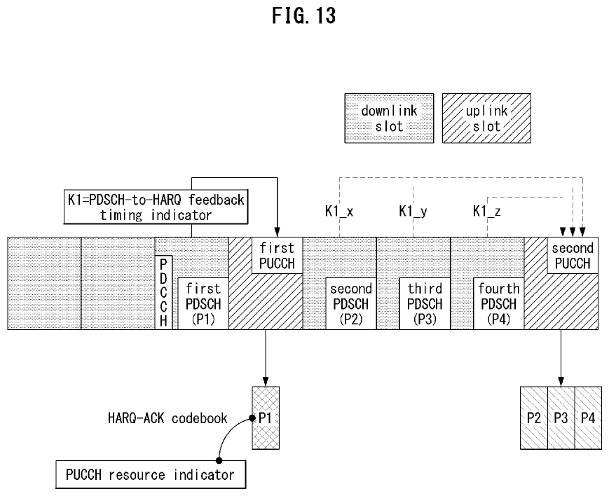

FIG. 13 is a conceptual diagram illustrating a fourth exemplary embodiment of a HARQ feedback method for a plurality of PDSCHs in a communication system.

Referring to FIG. 13, for a PDSCH dynamically scheduled by a PDCCH, the terminal may determine a PUCCH resource and a timing for a HARQ feedback for the PDSCH (i.e., first PDSCH) according to a PUCCH resource indicator (e.g., PUCCH resource indicator defined in Table 2) and a PDSCH-to-HARQ feedback timing indicator (e.g., PUCCH resource indicator defined in Table 2) included in the PDCCH (i.e., DCI) received from the base station. The terminal may generate a HARQ feedback for the first PDSCH received from the base station, and transmit the generated HARQ codebook in a slot according to the slot offset (i.e., PDSCH-to-HARQ feedback timing indicator) through a resource (e.g., first PUCCH) indicated by the PUCCH resource indicator. The base station may receive the HARQ codebook from the terminal through the resource (e.g. first PUCCH) indicated by the PUCCH resource indicator within the slot according to the slot offset (i.e., PDSCH-to-HARQ feedback timing indicator), and identify the HARQ feedback for the first PDSCH included in the codebook.

Then, the terminal may receive a second PDSCH (i.e., PDSCH for P2), a the third PDSCH (i.e., PDSCH for P3), and a fourth PDSCH (i.e., PDSCH for P4) from the base station according to the SPS. The terminal may generate a HARQ codebook including a HARQ feedback for the second PDSCH, a HARQ feedback for the third PDSCH, and a HARQ feedback for the fourth PDSCH received from the base station. The terminal may transmit the HARQ feedbacks for the PDSCHs received according to the SPS in a PUCCH resource (e.g., second PUCCH) according to the slot offsets (e.g., K1_x for the second PDSCH, K1_y for the third PDSCH, and K1_z for the fourth PDSCH) configured by the base station to the terminal through RRC signaling. The base station may receive the HARQ codebook from the terminal in the slot (e.g., second PUCCH) according to the slot offsets, and may identify the HARQ feedback for the second PDSCH, the HARQ feedback for the third PDSCH, and the HARQ feedback for the fourth PDSCH, which are included in the HARQ codebook. That is, the terminal may follow the HARQ feedback methods of the first to third exemplary embodiments described above only for the PDSCHs according to the SPS.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the exemplary embodiments of the present disclosure and their advantages have been described in detail, it should be understood that various changes, substitutions and alterations may be made herein without departing from the scope of the present disclosure.

What is claimed is:

1. An operation method of a terminal in a communication system, the operation method comprising:
receiving configuration information of a semi-persistent scheduling (SPS) from a base station, the configuration information including a first hybrid automatic repeat request (HARQ) offset for first data and a second HARQ offset for second data;
receiving control information including information indicating activation of the SPS from the base station;
receiving the first data and the second data from the base station based on the configuration information of the SPS;
generating a first HARQ codebook including a first HARQ feedback for the first data and a second HARQ feedback for the second data; and
transmitting the first HARQ codebook to the base station on a first physical uplink control channel (PUCCH) indicated by the first HARQ offset and the second HARQ offset,
wherein a value of the first HARQ offset is different from a value of the second HARQ offset.

2. The operation method according to claim 1, wherein the configuration information of the SPS includes at least one of a number of slots, an index of an uplink slot including the first PUCCH for the first HARQ feedback and the second HARQ feedback, and a first PUCCH resource list of PUCCH resources capable of accommodating both the first HARQ feedback and the second HARQ feedback.

3. The operation method according to claim 2, wherein when the SPS is configured in the terminal, the first PUCCH resource is determined according to the first PUCCH resource list included in the configuration information of the SPS.

4. The operation method according to claim 1, further comprising receiving the first data again from the base station when the first HARQ feedback corresponds to negative acknowledgment (NACK).

5. The operation method according to claim 1, further comprising:
receiving third data from the base station based on the configuration information of the SPS;
generating a second HARQ codebook including a third HARQ feedback for the third data; and
when a delay time for the third HARQ feedback is required, transmitting the second HARQ codebook to the base station on a second PUCCH indicated by a third HARQ offset included in the configuration information of the SPS,
wherein the second PUCCH is included in a subsequent uplink slot contiguous to the uplink slot including the first PUCCH.

6. An operation method of a base station in a communication system, the operation method comprising:
transmitting configuration information of a semi-persistent scheduling (SPS) to a terminal, the configuration information including a first hybrid automatic repeat request (HARQ) offset for first data and a second HARQ offset for second data;
transmitting control information including information indicating activation of the SPS to the terminal;
transmitting the first data and the second data to the terminal based on the configuration information of the SPS; and
receiving, from the terminal, a first HARQ codebook including a first HARQ feedback for the first data and a second HARQ feedback for the second data on a first physical uplink control channel (PUCCH) indicated by the first HARQ offset and the second HARQ offset,
wherein a value of the first HARQ offset is different from a value of the second HARQ offset.

7. The operation method according to claim 6, wherein when the SPS is configured in the terminal, the first PUCCH resource is determined according to a first PUCCH resource list included in the configuration information of the SPS.

8. The operation method according to claim 6, further comprising:
transmitting third data to the terminal based on the configuration information of the SPS;
when a delay time for a third HARQ feedback for the third data is required, receiving, from the terminal, a second HARQ codebook including the third HARQ feedback on a second PUCCH indicated by a third HARQ offset included in the configuration information of the SPS,
wherein the second PUCCH is included in a subsequent uplink slot contiguous to the uplink slot including the first PUCCH.

9. A terminal in a communication system, the terminal comprising:
a processor;
a memory electronically communicating with the processor; and
instructions stored in the memory,
wherein when executed by the processor, the instructions cause the terminal to:
receive configuration information of a semi-persistent scheduling (SPS) from a base station, the configuration information including a first hybrid automatic repeat request (HARQ) offset for first data and a second HARQ offset for second data;
receive control information including information indicating activation of the SPS from the base station;
receive the first data and the second data from the base station based on the configuration information of the SPS;
generate a first HARQ codebook including a first HARQ feedback for the first data and a second HARQ codebook including a second HARQ feedback for the second data;
transmit the first HARQ codebook to the base station on a first physical uplink control channel (PUCCH) indicated by the first HARQ offset; and
when a delay time for the second HARQ feedback is required, transmitting the second HARQ codebook to the base station on a second PUCCH indicated by the second HARQ offset,
wherein a value of the first HARQ offset is different from a value of the second HARQ offset.

10. The terminal according to claim 9, wherein the instructions further cause the terminal to receive third data from the base station based on the configuration information of the SPS, wherein the second HARQ codebook further includes a third HARQ feedback for the third data, the configuration information of the SPS further includes a third HARQ offset for the third data, and the third HARQ offset indicates the second PUCCH.

11. The terminal according to claim 10, wherein the configuration information of the SPS includes at least one of a number of slots, an index of an uplink slot including the first PUCCH for the first HARQ feedback, an index of an uplink slot including the second PUCCH for the second HARQ feedback and the third HARQ feedback, a first PUCCH resource list of PUCCH resources capable of accommodating the first HARQ feedback, and a second PUCCH resource list of PUCCH resources capable of accommodating both the second HARQ feedback and the third HARQ feedback.

12. The terminal according to claim 11, wherein when the SPS is configured in the terminal, the first PUCCH resource is determined according to the first PUCCH resource list included in the configuration information of the SPS, and the second PUCCH resource is determined according to the second PUCCH resource list included in the configuration information of the SPS.
